(19) United States
(12) Patent Application Publication
(10) Pub. No.: US 2022/0121748 A1
(43) Pub. Date: Apr. 21, 2022

(54) MODIFICATIONS TO FIRMWARE FUNCTIONALITY

(71) Applicant: Hewlett-Packard Development Company, L.P., Spring, TX (US)

(72) Inventors: Baraneedharan Anbazhagan, Spring, TX (US); Christopher H. Stewart, Spring, TX (US); Richard Bramley, Mansfield, MA (US)

(73) Assignee: Hewlett-Packard Development Company, L.P., Spring, TX (US)

(21) Appl. No.: 17/288,546

(22) PCT Filed: Jul. 3, 2019
(86) PCT No.: PCT/US2019/040611

§ 371 Date: Apr. 25, 2021

(51) Int. Cl. G06F 21/57; G06F 21/62; G06F 21/60

(52) U.S. Cl. CPC G06F 21/572; G06F 21/606; G06F 21/602; G06F 21/629

(57) ABSTRACT

According to examples, an apparatus may include a memory storing a firmware and a processor. The processor may receive a request to modify the firmware, in which the request may be associated with a first credential. The processor may also determine, based on the first credential, whether modification of the firmware is authorized and based on a determination that modification of the firmware is authorized, display a set of defined functionalities for the firmware that are authorized to be modified. The processor may further receive a modification to a functionality in the set of defined functionalities that are authorized to be modified and may apply the received modification to the functionality.

### BACKGROUND

Many types of electronic devices, including computing devices, may include firmware. Firmware may be defined as software that may provide low level control for hardware of the computing devices. Firmware may be stored on non-volatile memory of a computing device and may have various settings that may control a functionality of the firmware. In many types of electronic devices, firmware may not be changed, while in other types of electronic devices, the firmware may be changed. For instance, the firmware in some types of electronic devices may be updated to fix bugs or to add features to the firmware. Unified Extensible Firmware Interface (UEFI) and Basic Input/Output System (BIOS) are examples of firmware that may be executed in computing devices.

### BRIEF DESCRIPTION OF THE DRAWINGS

Features of the present disclosure are illustrated by way of example and not limited in the following figure(s), in which like numerals indicate like elements, in which:

FIG. 1 depicts a block diagram of an example apparatus that may modify a functionality of a firmware;

FIG. 2 shows a block diagram of an example system that may include the example apparatus depicted in FIG. 1;

FIG. 3 shows a block diagram of an example apparatus that may modify a functionality of a firmware;

FIG. 4 shows a flow diagram of an example method for modifying a firmware functionality; and

FIG. 5 depicts a block diagram of an example non-transitory computer readable medium that may have stored thereon machine readable instructions for modifying a setting of a bootup firmware.

### DETAILED DESCRIPTION

Disclosed herein are apparatuses, systems, methods, and computer readable media that may modify a functionality of a firmware, such as a bootup firmware. For example, a processor that may determine whether a requested modification of a firmware functionality is authorized based on whether a first credential decrypts or unlocks access to the firmware. The processor may determine whether the first credential decrypts or unlocks access to the firmware based on whether the first credential decrypts or unlocks the firmware.

In addition, the processor may determine whether the requested modification is included in a set of defined functionalities, in which the set of defined functionalities identifies the functionalities that are authorized to be modified. The processor may allow for the modification of the requested functionality in instances in which the first credential, which the processor may receive with the request or from the same entity as the entity that submitted the request, decrypts or unlocks access to the firmware and the requested modification is included in the set of defined functionalities. In this regard, the processor may deny the requested modification to the functionality in instances in which the first credential does not decrypt or unlock access to the firmware and/or the requested modification is not included in the set of defined functionalities.

As also disclosed herein, access to the firmware may be secured prior to or during installation of the firmware. Thus, for instance, a programmer, an installer, or the like may have encrypted the firmware and may have provided the proper credential to decrypt or unlock access to the firmware to selected personnel. In this regard, access to the firmware may be controlled by an entity other than an end user of the firmware. In some examples, the granted access may enable an entity other than the end user, such as an administrator, an IT personnel, or the like, to define the set of defined functionalities. That is, the entity other than the end user may define the set of firmware functionalities an authorized end user may modify. In this regard, when the entity other than the end user seeks to change the functionalities in the set of defined functionalities, the entity may make this change directly. For instance, the entity may wish to have some special behavior in the firmware. As a result, a programmer of the firmware or an installer of the firmware may not need to make the change for the entity, e.g., may not need to create a customized firmware to make the changes that the entity seeks.

A concern associated with enabling modification of firmware functionalities may be that unauthorized modification of firmware functionalities may result in undesirable and/or improper firmware operations. For instance, unauthorized modification of firmware functionalities may result in physical harm to a computer system, loss or destruction of data, failure of a computer system to boot, or the like. Through examples disclosed herein, certain entities, such as users having higher levels of authorization may define, e.g., customize, the firmware functionalities that other users having lower levels of authorization may modify. In addition, the users having the lower levels of authorization may modify the functionalities in the set of defined functionalities.

Access to the definition of the set of defined functionalities as well as access to the modification of the functionalities may thus be controlled to prevent unauthorized access to and modification of firmware functionalities without requiring that custom firmware be created to achieve certain firmware behaviors. As a result, secure modification of the firmware functionalities may be achieved, which may enable an apparatus on which the firmware is executed to operate using updated settings in a secure manner. That is, the firmware in an apparatus may be updated in an efficient and secure manner, which may enable the apparatus as well as the processor, to operate securely. In addition, as the firmware may be updated in a relatively quick manner, the firmware may be brought to a safer and more secure operational level in a relatively quick manner, which may reduce malicious access to the firmware, which may not be blocked without the modification to the firmware.

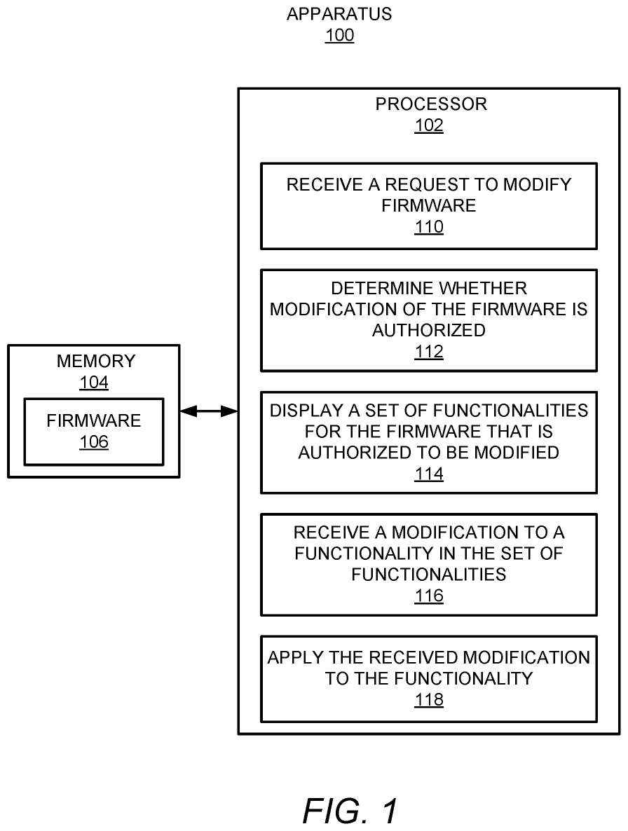

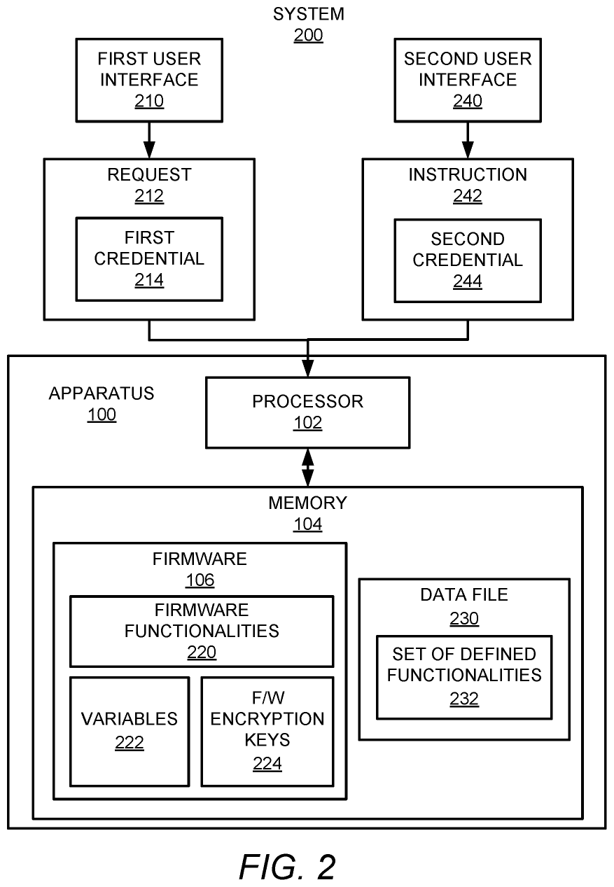

Reference is first made to FIGS. 1 and 2. FIG. 1 shows a block diagram of an example apparatus 100 that may modify a functionality of a firmware. FIG. 2 shows a block diagram of an example system 200 that may include the example apparatus 100 depicted in FIG. 1. It should be understood that the apparatus 100 depicted in FIG. 1 and/or the system 200 depicted in FIG. 2 may include additional features and that some of the features described herein may be removed and/or modified without departing from the scopes of the apparatus 100 and/or the system 200.

The apparatus 100 may include a processor 102 and a memory 104 and the apparatus 100 may be a server, a node in a network (such as a data center), a personal computer, a laptop computer, a tablet computer, a smartphone, a network gateway, a network router, an electronic device such as Internet of Things (IoT) device, and/or the like. The processor 102 may be a semiconductor-based microprocessor, a central processing unit (CPU), an application specific integrated circuit (ASIC), a field-programmable gate array (FPGA), and/or other hardware device. Although the apparatus 100 is depicted as having a single processor 102, it should be understood that the apparatus 100 may include additional processors and/or cores without departing from a scope of the apparatus 100. In this regard, references to a single processor 102 as well as to a single memory 104 may be understood to additionally or alternatively pertain to multiple processors 102 and multiple memories 104.

The memory 104 may be, for example, a non-volatile memory such as, Read Only Memory (ROM), flash memory, solid state drive, Random Access memory (RAM), an Electrically Erasable Programmable Read-Only Memory (EEPROM), a storage device, an optical disc, or the like. By way of example, the memory 104 may be non-volatile random access memory (NVRAM), which may be implemented to store and return data over a serial programmable interface (SPI) bus/connection. In some examples and as shown in FIG. 1, the memory 104 may have stored thereon a firmware 106. The firmware 106 may generally be defined as a set of instructions that may provide low-level control for hardware in and/or attached to the apparatus 100. In some instances, the firmware 106 may provide a standardized operating environment for more complicated software, such as an operating system, in the apparatus 100 or may act as an operating system for the apparatus 100. According to examples, the firmware 106 may be Unified Extensible Firmware Interface (UEFI) or Basic Input/Output System (BIOS). In these examples, the firmware 106 may be termed “bootup firmware” 106.

In examples in which the firmware 106 is UEFI or BIOS, the firmware 106 may ensure that all of the components in and/or connected to the apparatus 100 are functional. Particularly, the firmware 106 may be responsible for establishing the association between components (e.g., disk drives, video controllers, keyboard, mouse, etc.) and the operating system that the apparatus 100 executes. The firmware 106 may also include data and instructions that may enable the operating system to access hardware of the apparatus 100. In addition, during the apparatus 100 bootup, the firmware 106 may first perform a Power On Self Test (POST) and may then proceed to load the operating system.

Functionalities of the firmware 106 may be modified in various instances. For instance, the firmware 106 functionalities that may be modified may include various parameters stored within a nonvolatile memory. Examples of the functionalities may include power management options, peripheral device boot sequence, security options, and/or the like. In addition, as disclosed herein, a user (or program) may modify the functionalities as long as the user (or program) has the appropriate privilege level to make the modification and the functionality is included in a set of functionalities that identifies functionalities that are allowed to be modified. As used herein, the functionalities may also be termed “configuration settings” or merely “settings.”

According to examples disclosed herein, modification to the functionalities may be limited to requests or instructions that have a proper credential to modify the functionalities. Additionally, to reduce the potential risks associated with enabling modifications to the functionalities of the firmware 106, the functionalities that may be modified may be limited to a certain set of authorized modifications. In some examples, a user having a higher access level, e.g., a system administrator, a member of an IT department, or the like, may define the set of authorized modifications for a user having a lower access level, e.g., an employee, a vendor, a customer, or the like. In addition or alternatively, the set of authorized modifications may be defined during installation of the firmware 106. As discussed herein, cryptographic signing (or digital signing) and cryptographic signature verification may be used to prevent unauthorized modification to the functionalities identified in the set of defined functionalities 232 of the firmware 106 as well as those functionalities outside of the set of defined functionalities 232.

As shown in FIG. 1, the processor 102 may perform various operations 110-118 to modify a functionality of the firmware 106. The operations 110-118 may be hardware logic blocks that the processor 102 may execute. In other examples, the operations 110-118 may be machine readable instructions, e.g., non-transitory computer readable instructions. In other examples, the apparatus 100 may include a combination of instructions and hardware logic blocks to implement or execute functions corresponding to the operations 110-118.

The processor 102 may execute the operation 110 to receive a request 212 to access the firmware 106, in which the request 212 may be associated with a first credential 214. As shown in FIG. 2, the processor 102 may receive the request 212 and the first credential 214 from a first user interface 210. In this example, the first credential 214 may be supplied with the request 212; while in other examples, the first credential 214 may be supplied separately from the request 212. The first credential 214 may be a password, a decryption key stored on a key card, a biometric feature, and/or another type of secure credential.

The first user interface 210 may include, for instance, an input device for the apparatus 100 through which a first user may input the first request 212 and/or the credential 214. In some examples, the input device may be a peripheral device connected either through a wired connection or wirelessly to the apparatus 100, such as a keyboard, mouse, trackpad, pen, or the like. In other examples, the input device may be detached from the apparatus 100, such as a computing device, a tablet computer, a smartphone, or the like, that may communicate with the apparatus 100 via a wired or wireless communication protocol. In any regard, the first user interface 210 may include the input device as well as any hardware and/or software that facilitate the connection between the input device and the apparatus 100 through which the request 212 and/or the first credential 214 may be communicated.

The request 212 may be a request to modify the firmware 106, such as to modify a functionality of the firmware 106. The functionality of the firmware 106 that may be modified may include, for instance, a secure boot, secure firmware boot keys, a predefined command support, locking of the firmware 106 version, and/or the like.

According to examples, the firmware 106 may be encrypted with an encryption key. Particularly, for instance, cryptographic signature may be applied on the firmware 106. In addition, the encryption key may be an encryption key of the firmware 106 developer, an encryption key of an installer of the firmware 106, or an encryption key of an entity other than an entity that owns or operates the apparatus 100. In other words, the encryption key may be an encryption key that is not accessible or in the control of an end user entity that ultimately has access to the firmware 106 on the apparatus 100.

In examples in which the firmware 106 is encrypted through a cryptographic signature, the first credential 214 may be a decryption key and if the first credential 214 is an appropriate key (e.g., a matching decryption key) to the encryption key, the first credential 214 may be used to decrypt the firmware 106. That is, for instance, the firmware 106 may be encrypted using a private encrypt function of an asymmetric decryption scheme and the first credential 214 may decrypt the encrypted hash using a public decrypt function of the asymmetric decryption scheme. The encryption of the hash of the firmware 106 may equivalently be called cryptographic signing (or digital signing) and the decryption of the encrypted hash may equivalently be called cryptographic signature verification (or digital signature verification).

As shown in FIG. 2, the firmware 106 may include firmware functionalities 220, variables 222, and firmware (F/W) encryption keys 224. The firmware functionalities 220 may include the settings of the functionalities of the firmware 106. The firmware functionalities 220 may be set at initial settings by, for instance, by the programmer of the firmware 106, by an installer of the firmware 106, by an administrator, and/or the like. In addition, some of the firmware functionalities 220 may be modified as discussed herein. The variables 222 may provide a way to store data, in particular non-volatile data, that may be shared between the firmware 106 and an operating system or firmware applications. For instance, the variables 222 may be key/value pairs and may be used to keep crash messages in non-volatile random access memory (NVRAM) after a crash for the operating system to retrieve after a reboot.

The F/W encryption keys 224 may be used to encrypt the variables 222 to ensure that the elements that should execute, for instance, during bootup, are executed. By way of example, the F/W encryption keys 224 may sign the elements that are loaded during boot and thus, the elements may not be loaded during boot unless the elements are verified. According to examples, one of the F/W encryption keys 224 may be used to sign the settings and the defaults of the firmware 106. As show, the F/W encryption keys 224 may be stored in the firmware 106 or in the data file 230, which may also be termed a secure boot variable database.

The memory 104 may also include a data file 230 that may include a set of defined functionalities 232 that a user having a first credential 214 that decrypts or otherwise unlocks the firmware 106 may modify. The set of defined functionalities 232 stored in the data file 230 may correspond to the firmware functionalities 220 that may be modified, e.g., the firmware functionalities 220 that are authorized to be modified. That is, the set of defined functionalities 232 may identify the firmware functionalities 220 that a user may be authorized to modify and thus, the user may not modify the firmware functionalities 220 that are not identified in the set of defined functionalities 232. As discussed herein, a programmer, an installer, or a second user may define the set of defined functionalities 232.

The processor 102 may use the set of defined functionalities 232 to limit the firmware functionalities 220 that a first user may modify. As such, for instance, the first user may not be authorized or otherwise permitted to modify all of the firmware functionalities 220. Examples of the firmware functionalities 220 that a first user may be authorized to modify may include, force a secure boot to be enabled, prevent secure firmware boot keys from being cleared, added, or modified, force a predefined command support to be disabled, provide trusted input to other code, lock down a version of the firmware, and/or the like.

The processor 102 may execute the operation 112 to determine, based on the first credential 214, whether modification of the firmware 106 is authorized. The processor 102 may determine whether modification of the firmware 106 is authorized based on a determination as to whether the first credential 214 decrypts the firmware 106 or, equivalently, decrypts a hash of the firmware 106. That is, the processor 102 may apply the first credential 214 to the encrypted hash of the firmware 106 and may determine whether the first credential 214 decrypts the encrypted hash. In other words, the hash of the firmware 106 may be cryptographically signed (or digitally signed) and the processor 102 may perform a cryptographic signature verification (or digital signature verification encryption) using the first credential 214. Based on a determination that the first credential 214 decrypts the firmware 106 (e.g., passes the cryptographic signature verification), the processor 102 may determine that modification of the firmware 106 is authorized.

The processor 102 may execute the operation 114 to, based on a determination that modification of the firmware 106 is authorized, display a set of defined functionalities 232 for the firmware 106 that may be modified, e.g., authorized to be modified. In other words, the processor 102 may cause the set of defined functionalities 232 to be displayed on a display (not shown) of or connected to the apparatus 100. The set of defined functionalities 232 may include a set of the firmware functionalities 220 that a user that provides the first credential 214 may be authorized to modify. As shown in FIG. 2, the set of defined functionalities 232 may be stored in the data file 230, which may also be stored in the memory 104. The set of defined functionalities 232 may also be termed a list of settings or other types of equivalent terms.

The processor 102 may execute the operation 116 to receive a modification to a functionality in the set of defined functionalities 232. That is, the processor 102 may receive a request 212 to modify a particular functionality. The functionality requested to be modified may be included in the set of defined functionalities 232 or may not be included in the set of defined functionalities 232. In an instance in which the functionality requested to be modified is not included in the set of defined functionalities 232, the processor 102 may deny the modification in the request 212. Particularly, the processor 102 may discard the request 212.

However, based on a determination that the functionality requested to be modified is included in the set of defined functionalities 232, the processor 102 may execute the instructions 118 to apply the received modification to the functionality. Particularly, for instance, the processor 102 may modify the firmware functionality 220 corresponding to the functionality in the set of defined functionalities 232 that is requested to be modified. In other words, the processor 102 may modify a setting of the firmware functionality 220 corresponding to the functionality.

According to examples, a second user may define the set of defined functionalities 232. For instance, a second user may define the firmware functionalities 220 that are included in the set of defined functionalities 232 and/or may change the functionalities that are included in the set of defined functionalities 232. The second user may be an administrator or other user having, for instance, identical or greater access rights to the apparatus 100 and/or the firmware 106 than the user of the first user interface 210. In these examples, the second user may define or change the functionalities included in the set of defined functionalities 232 through a second user interface 240. For instance, the second user may submit an instruction 242 to define the functionalities in the set of defined functionalities 232, e.g., define and/or change the functionalities included in the set of defined functionalities 232.

The instruction 242 may be associated with a second credential 244 and the processor 102 may receive the instruction 242 and the second credential 244 from the second interface 240. In some examples, the second credential 244 may be supplied with the instruction 242; while in other examples, the second credential 244 may be supplied separately from the instruction 242. The second credential 244 may be a password, a key stored on a key card, a biometric feature, and/or other type of secure credential and may differ from the first credential 214.

The second user interface 240 may include, for instance, an input device for the apparatus 100 through which the second user may input the instruction 242 and/or the second credential 244. In some examples, the input device may be a peripheral device connected either through a wire or wirelessly to the apparatus 100, such as a keyboard, mouse, trackpad, pen, or the like. In other examples, the input device may be detached from the apparatus 100, such as a computing device, a tablet computer, a smartphone, or the like, that may communicate with the apparatus 100 via a wired or wireless communication protocol. In any regard, the second user interface 240 may include the input device as well as any connection between the input device and the apparatus 100 through which the instruction 242 and/or the second credential 244 may be communicated.

According to examples, the set of defined functionalities 232 and/or the data file 230 may be encrypted. Alternatively, a hash of the set of defined functionalities 232 and/or the data file 230 may be encrypted. In these examples, the processor 102 may determine that the second user is authorized to define the set of defined functionalities 232 based on a determination that the second credential 244 decrypts or otherwise unlocks access to the set of defined functionalities 232 and/or the data file 230. Likewise, the processor 102 may determine that the second user is not authorized to define the set of defined functionalities 232 based on a determination that the second credential 244 does not decrypt or otherwise unlock the set of defined functionalities 232 and/or the data file 230. Based on a determination that the second user is authorized to define the set of defined functionalities 232, the processor 102 may define the set of defined functionalities 232 as requested in the instruction 242.

According to examples, the decryption (cryptographic signature verification) to define the functionalities included in the set of defined functionalities 232 may differ from the decryption (cryptographic signature verification) to modify a functionality included in the set of defined functionalities 232. Thus, for instance, different encryption keys may be used to encrypt or sign the set of defined functionalities 232 and/or the data file 230 for each of these types of operations.

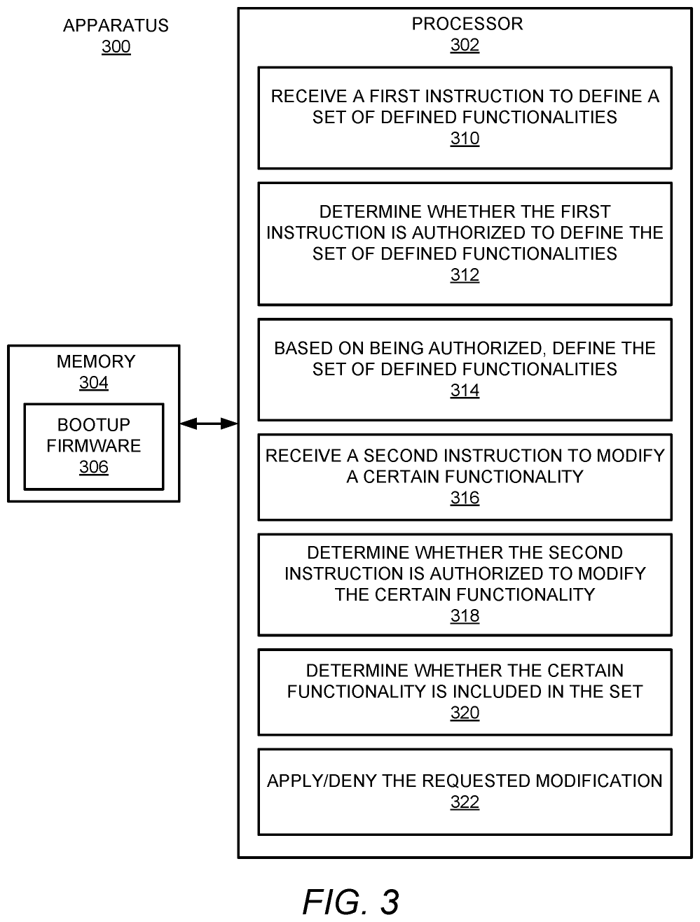

Reference is now made to FIG. 3, which shows a block diagram of an example apparatus 300 that may modify a functionality of a bootup firmware 306. It should be understood that the apparatus 300 depicted in FIG. 3 may include additional features and that some of the features described herein may be removed and/or modified without departing from the scope of the apparatus 300. The description of the apparatus 300 is made with reference to the features shown in FIGS. 1 and 2.

As shown in FIG. 3, the apparatus 300 may include a processor 302 and a memory 304. The processor 302 may be equivalent to the processor 102 and the memory 304 may be equivalent to the memory 104 depicted in FIGS. 1 and 2 and may thus include the components described in FIGS. 1 and 2 with respect to the processor 102 and the memory 304. In addition, a bootup firmware 306 may be stored in the memory 304, in which the bootup firmware 306 which may be equivalent to the firmware 106 depicted in FIGS. 1 and 2. However, the bootup firmware 306 may be firmware that may control bootup operations, such as BIOS, UEFI, or other such bootup firmware.

The processor 302 may execute the operation 310 to receive a first instruction 242 to define and/or modify a set of defined functionalities 232 of a bootup firmware 306 (as shown in FIG. 2). The processor 302 may receive the first instruction 242 as discussed above with respect to FIG. 2.

The processor 302 may execute the operation 312 to determine whether the first instruction 242 is authorized to define the set of defined functionalities 232. The processor 302 may make this determination based on the second credential 244, which may equivalently be termed a higher level credential herein, as discussed above with respect to FIG. 2. For instance, the processor 302 may determine whether the second credential 244 matches a first predefined key that may decrypt or otherwise unlock an encrypted hash of the set of defined functionalities 232 and/or the data file 230.

The processor 302 may execute the operation 314 to, based on a determination that the first instruction 242 is authorized to define the set of defined functionalities 232, define the set of defined functionalities 232 according to the first instruction 242. For instance, the processor 302 may define and/or change the functionalities that are included in the set of defined functionalities 232, e.g., the firmware functionalities 220 that a first user may be authorized to modify, as requested in the first instruction 242.

The processor 302 may execute the operation 316 to receive a second instruction, which may be equivalent to the request 212 depicted in FIG. 2, to modify a particular functionality of the bootup firmware 306. The processor 302 may receive the second instruction 212 as discussed herein with respect to receipt of the request 212 in FIG. 2.

The processor 302 may execute the operation 318 to determine whether the second instruction 212 is authorized to modify the particular functionality of the bootup firmware 306. The processor 302 may make this determination based on whether the first credential 214, which may equivalently be termed a lower level credential, decrypts or otherwise unlocks the hash of the firmware 106 as discussed herein. In addition, or alternatively, the processor 302 may make this determination based on whether the first credential 214 decrypts or otherwise unlocks a hash of the set of defined functionalities 232 and/or a hash of the data file 230. In any regard, the processor 302 may make this determination based on whether the first credential 214, e.g., the lower level credential, matches a second predefined key that may decrypt or otherwise unlock an encrypted hash of the firmware 306, the set of defined functionalities 232, and/or the data file 230.

The processor 302 may execute the operation 320 to determine whether the particular functionality to which the second instruction 212 to modify was received is included in the set of defined functionalities 232 available for modification. For instance, the processor 302 may compare the particular functionality identified in the second instruction 212 with the functionalities identified in the set of defined functionalities 232 to make this determination.

The processor 302 may execute the operation 322 to either apply or deny the requested modification to the particular functionality. That is, based on a determination that the second instruction 212 is authorized to modify the bootup firmware 306 and that the particular functionality is included in the set of defined functionalities 232 available for modification, the processor 302 may apply the modification to the particular functionality. However, based on a determination that the second instruction 212 is not authorized to modify the bootup firmware 306 and/or that the particular functionality is not included in the set of defined functionalities 232 available for modification, the processor 302 may deny the second instruction 212 to modify the particular functionality. That is, the processor 302 may not apply the modification to the particular functionality.

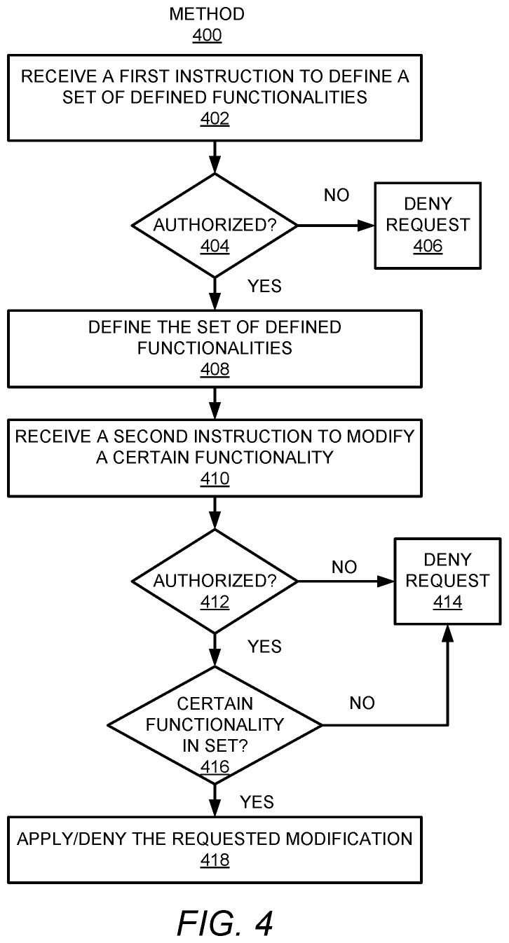

Various manners in which the processor 102, 302 may operate are discussed in greater detail with respect to the method 400 depicted in FIG. 4. Particularly, FIG. 4 depicts a flow diagram of a method 400 for modifying a firmware functionality. It should be understood that the method 400 depicted in FIG. 4 may include additional operations and that some of the operations described therein may be removed and/or modified without departing from the scopes of the method 400. The description of the method 400 is made with reference to the features depicted in FIGS. 1-3 for purposes of illustration.

At block 402, the processor 102, 302 may receive a first instruction 242 to define a set of defined functionalities 232 (as shown in FIG. 2) of a bootup firmware 306. At block 404, the processor 102, 302 may determine whether the first instruction 242 is authorized to define the set of defined functionalities 232. Based on a determination that the first instruction 242 is not authorized to define the set of defined functionalities 232, at block 406, the processor 102, 302 may deny the request as included in the first instruction 242. However, based on a determination that the first instruction 242 is authorized to define the set of defined functionalities 232, at block 408, the processor 102, 302 may define the set of defined functionalities 232.

At block 410, the processor 102, 302 may receive a second instruction 212. At block 412, the processor 102, 302 determine whether the second instruction 212 is authorized to modify the particular functionality of the bootup firmware 306. Based on a determination that the second instruction 212 is not authorized to modify the particular functionality of the bootup firmware 306, at block 414, the processor 102, 302 may deny the request to modify the particular functionality of the bootup firmware 306. However, based on a determination that the second instruction 212 is authorized to modify the particular functionality of the bootup firmware 306, at block 416, the processor 102, 302 may apply the modification to the particular functionality.

Some or all of the operations set forth in the method 400 may be included as utilities, programs, or subprograms, in any desired computer accessible medium. In addition, the method 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

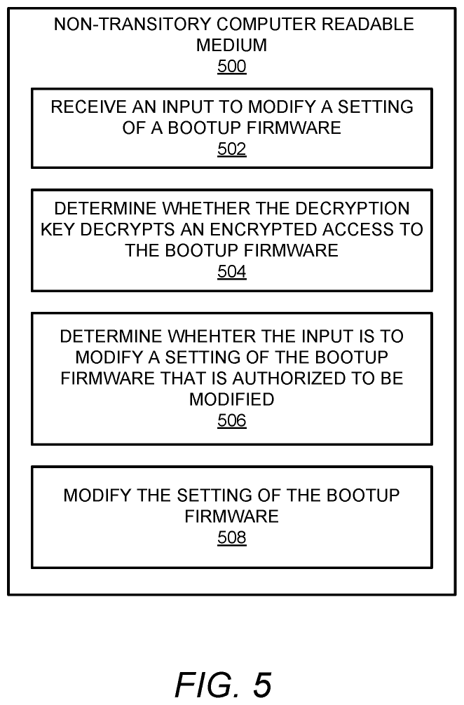

Turning now to FIG. 5, there is shown a block diagram of a non-transitory computer readable medium 500 that may have stored thereon machine readable instructions for modifying a setting of a bootup firmware 306. It should be understood that the computer readable medium 500 depicted in FIG. 5 may include additional instructions and that some of the instructions described herein may be removed and/or modified without departing from the scope of the computer readable medium 500 disclosed herein. The computer readable medium 500 may be a non-transitory computer readable medium. The term “non-transitory” does not encompass transitory propagating signals.

The computer readable medium 500 may have stored thereon machine readable instructions 502-508 that a processor, such as the processor 102, 302 depicted in FIGS. 1-3, may execute. The computer readable medium 500 may be an electronic, magnetic, optical, or other physical storage device that contains or stores executable instructions. The computer readable medium 500 may be, for example, Random Access memory (RAM), an Electrically Erasable Programmable Read-Only Memory (EEPROM), a storage device, an optical disc, and the like.

The processor may fetch, decode, and execute the instructions 502 to receive an input to modify a setting (e.g., firmware functionality 220) of a bootup firmware 106, 306, the input being associated with a decryption key (e.g., first credential 214). The processor may fetch, decode, and execute the instructions 504 to determine whether the decryption key (e.g., first credential 214) decrypts an encrypted access to the bootup firmware 106, 306. The processor may fetch, decode, and execute the instructions 506 to, based on a determination that the decryption key decrypts the encrypted access to the bootup firmware 106, 306, determine whether the input is to modify a setting of the bootup firmware 106, 306 that is authorized to be modified. The processor may fetch, decode, and execute the instructions 508 to, based on a determination that the input is to modify a setting of the bootup firmware 106, 306 that is authorized to be modified, modify the setting of the bootup firmware 106, 306.

According to examples, the processor may also determine whether the setting to be modified is included in a list of settings (e.g.., the set of defined functionalities 232) that are authorized to be modified. In addition, the processor may determine that the input is to modify a setting of the bootup firmware 106, 306 that is authorized to be modified based on the setting to be modified being included in the list of settings that are authorized to be modified. However, the processor may determine that the input is not to modify a setting of the bootup firmware that is authorized to be modified based on the setting to be modified not being included in the list of settings that are authorized to be modified.

What is claimed is:

1. An apparatus comprising:
a memory storing a firmware; and
a processor to:
receive a request to modify the firmware, the request being associated with a first credential;
determine, based on the first credential, whether modification of the firmware is authorized;
based on a determination that modification of the firmware is authorized, display a set of defined functionalities for the firmware that are authorized to be modified;
receive a modification to a functionality in the set of defined functionalities that are authorized to be modified; and
apply the received modification to the functionality.

2. The apparatus of claim 1, wherein the firmware is encrypted with an encryption key, and wherein the processor is further to:
determine whether the first credential decrypts the firmware; and
determine that modification of the firmware is authorized based on a determination that the first credential decrypts the firmware.

3. The apparatus of claim 2, wherein the encryption key and the first credential form parts of an asymmetric decryption key pair.

4. The apparatus of claim 2, wherein the encryption key resides in a secure boot variable database or in a setting of the firmware.

5. The apparatus of claim 1, wherein the set of defined functionalities for the firmware that is authorized to be modified includes:
force a secure boot to be enabled;
prevent secure firmware boot keys from being cleared, added, or modified;
force a predefined command support to be disabled;
provide trusted input to other code; and/or
lock down a version of the firmware.

6. The apparatus of claim 1, wherein the processor is further to:
receive an instruction to change the set of defined functionalities of the firmware to be available for modification;
determine whether the instruction is authorized to change the set of defined functionalities; and
based on a determination that the instruction is authorized to change the set of defined functionalities, change the set of defined functionalities according to the received instruction.

7. An apparatus comprising:
a memory storing a bootup firmware;
a processor to:
receive a first instruction to define a set of defined functionalities of the bootup firmware to be available for modification;
determine whether the first instruction is authorized to define the set of defined functionalities; and
based on a determination that the first instruction is authorized to define the set of defined functionalities, define the set of defined functionalities according to the first instruction.

8. The apparatus of claim 7, wherein the processor is further to:
based on a determination that the first instruction is not authorized to define the set of defined functionalities, deny the first instruction to define the set of defined functionalities.

9. The apparatus of claim 7, wherein the processor is further to:
receive a second instruction to modify a particular functionality of the bootup firmware;
determine whether the second instruction is authorized to modify the particular functionality of the bootup firmware;
determine whether the particular functionality is included in the set of defined functionalities available for modification; and
based on a determination that the second instruction is authorized to modify the bootup firmware and that the particular functionality is included in the set of defined functionalities available for modification, apply the modification to the particular functionality.

10. The apparatus of claim 9, wherein the processor is further to:
based on a determination that the second instruction is not authorized to modify the bootup firmware and/or that the particular functionality is not included in the set of defined functionalities available for modification, deny the second instruction to modify the particular functionality.

11. The apparatus of claim 9, wherein the first instruction is associated with a higher level credential and the second instruction is associated with a lower level credential, and wherein the processor is further to:
determine that the first instruction is authorized to define the set of defined functionalities based on the higher level credential matching a first predefined key; and
determine that the second instruction is authorized to modify the particular functionality based on the lower level credential matching a second predefined key.

12. A non-transitory computer readable medium on which is stored machine readable instructions that when executed by a processor, cause the processor to:
receive an input to modify a setting of a bootup firmware, the input being associated with a decryption key;
determine whether the decryption key decrypts an encrypted access to the bootup firmware;
based on a determination that the decryption key decrypts the encrypted access to the bootup firmware, determine whether the input is to modify a setting of the bootup firmware that is authorized to be modified; and
based on a determination that the input is to modify a setting of the bootup firmware that is authorized to be modified, modify the setting of the bootup firmware.

13. The non-transitory computer readable medium of claim 12, wherein the instructions are further to cause the processor to:
determine whether the setting to be modified is included in a list of settings that are authorized to be modified; and
determine that the input is to modify a setting of the bootup firmware that is authorized to be modified based on the setting to be modified being included in the list of settings that are authorized to be modified.

14. The non-transitory computer readable medium of claim 13, wherein the instructions are further to cause the processor to:
determine that the input is not to modify a setting of the bootup firmware that is authorized to be modified based on the setting to be modified not being included in the list of settings that are authorized to be modified.

15. The non-transitory computer readable medium of claim 12, wherein the firmware comprises a basic input/output system or a unified extensible firmware interface.
